(19) United States
(12) Patent Application Publication
(10) Pub. No.: US 2025/0175270 A1
(43) Pub. Date: May 29, 2025

(54) PHASE DIFFERENCE ESTIMATION BETWEEN ACCESS POINTS

(71) Applicant: Telefonaktiebolaget LM Ericsson (publ), Stockholm (SE)

(72) Inventors: Joao VIEIRA, HJÄRUP (SE); Pål FRENGER, LINKÖPING (SE); Erik G. LARSSON, LINKÖPING (SE)

(73) Assignee: Telefonaktiebolaget LM Ericsson (publ), Stockholm (SE)

(21) Appl. No.: 18/867,616

(22) PCT Filed: Apr. 24, 2023
(86) PCT No.: PCT/EP2023/060647

§ 371 Date: Nov. 20, 2024

(30) Foreign Application Priority Data
May 25, 2022 (SE) 2230162-6

(51) Int. Cl. H04B 17/364; H04W 56/00

(52) U.S. Cl. CPC H04B 17/364; H04W 56/0035

(57) ABSTRACT

There is provided techniques for estimating a phase difference between a first AP and a second AP. A first phase difference and a second phase difference between the first AP and the second AP are obtained from phase measurements on a first wideband signal having been transmitted by the first AP and received by the second AP and phase measurements on a second wideband signal having been transmitted by the second AP and received by the first AP. The first phase difference is associated with a first metric and the second phase difference is associated with a second metric. Hypothesis testing is performed for selecting one of the first phase difference and the second phase difference as the estimated phase difference between the first AP and the second AP based on which of the first metric and the second metric that best matches a hypothesis metric.

### TECHNICAL FIELD

Embodiments presented herein relate to a method, a network node, a computer program, and a computer program product for estimating a phase difference between a first access point and a second access point.

### BACKGROUND

The project leading to this application has received funding from the European Union's Horizon 2020 research and innovation programme under grant agreement No 101013425

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO systems, or just MIMO for short.

Distributed MIMO (D-MIMO, also referred to as cell-free massive MIMO, RadioStripes, RadioWeaves, and ubiquitous MIMO) is a candidate for the physical layer of the 6^{th} generation (6G) telecommunication system. D-MIMO is based on geographically distributing the antennas of the network and configure them to operate phase-coherently together. Deployments of D-MIMO networks may be used to provide good coverage and high capacity for areas with high traffic requirements such as factory buildings, stadiums, office spaces and airports, just to mention a few examples.

In a typical architecture, multiple access points (APs) are interconnected and configured such that two or more APs can cooperate in coherent decoding of data from a given user equipment (UE) served by the network, and such that two or more APs can cooperate in coherent transmission of data to a UE. The APs might thus collectively define the access part of the D-MIMO network. Each AP has one or more antenna panel. Each antenna panel might comprise multiple antenna elements that are configured to operate phase-coherently together.

Ideally, the transceiver chain at each antenna in every AP would be synchronized to the same phase reference or time reference; for a narrowband signal, a small time-shift is equivalent to a phase shift. In practice, there will be phase errors that stem from differences in effective propagation path lengths on uplink (UL) and downlink (DL) inside the transceiver chain circuitry, from mismatches in the sampling timing (such as synchronization of the inphase/quadrature (I/Q) mixers), etc. These phase errors are unknown a priori, and their collective effect can be described in terms of a phase offset tᵢ per transmitter chain (indexed by i) and a phase offset rᵢ for each receiver chain i. More specifically, consider a fictitious absolute phase (time) reference (for example a global phasor that rotates at the speed f_{c} revolutions per second). Define tᵢ to be the value of the local phasor of transmitter chain i when the global phasor points to zero. Define rᵢ to be the value of the local phasor of receiver chain i when the global phasor is zero. Ideally, tᵢ=rᵢ=c, for some constant c, but in practice tᵢ≠rᵢ, tᵢ≠tⱼ, etc. This motives the need for calibration.

Calibration in D-MIMO networks concerns compensating for the above disclosed transceiver phase differences in different ways. One approach is to conduct over-the-air (OTA) measurements between pairs of AP antennas, thereby avoiding the need for dedicated cables for calibration or the need for involving user equipment served by the APs in the calibration process.

Different applications, implementations, and deployments of D-MIMO networks entail different requirements on calibration. For simplicity, but without loss of generality, existing schemes for calibrating D-MIMO networks will henceforth be divided into two types, namely (1) weak reciprocity calibration, and (2) strong reciprocity calibration. In what follows, to provide context, the concepts of weak and strong calibration are disclosed in more detail. The disclosed methodologies allow weak and strong calibration using narrowband measurements.

In terms of weak reciprocity calibration, this type of calibration that enables reciprocity-based beamforming and requires only weak reciprocity calibration.

For reciprocity-based beamforming in time division duplex (TDD) operation with a single multiple-antenna AP, all channel impulse responses are estimated based on UL pilot signals. It is then sufficient to perform weak reciprocity calibration in the sense that it is only the relation between UL and DL that is compensated, which can be achieved by making bidirectional narrowband (i.e., at a given subcarrier) measurements between pairs of antennas of the antenna array. This type of calibration results in a set of compensation factors that must be applied per antenna, and that depend on the relation between t₁ and rᵢ for antenna i, in the DL beamforming. Knowledge of any antenna mutual coupling coefficients between the antennas in the AP is not necessary for this type of calibration.

For reciprocity-based beamforming in TDD with multiple APs, one joint (weak) reciprocity calibration can be performed. Again, knowledge of the mutual coupling coefficients between the antennas of the same AP, or knowledge of the propagation channel between antennas of different APs, is not necessary. Alternatively, each AP can be individually reciprocity-calibrated and then bidirectional measurements between the APs can be used to perform joint (weak) phase alignment.

In terms of strong reciprocity calibration, this type of calibration is required for applications that rely on phase measurements between antennas in one direction of the link (e.g., UL), such as angle-of-arrival estimation, positioning, channel fingerprinting, environment sensing, and beamforming, beam sweeping, using angular or geometric channel information.

When using a single multiple-antenna AP for these applications, the AP can be strongly calibrated by a sequence of bidirectional narrowband measurements being made between the antennas in the AP similar to in the weaker form of calibration. However, the antenna mutual coupling coefficients between the antennas in the AP are required to be known. This in turn imposes stronger requirements for the calibration, which motivates the use of the term “strong calibration” to refer to this type of calibration. Given that the mutual coupling gains are known, the phases, namely {rᵢ} and {tᵢ}, associated with each receiver and transmitter chains can be estimated individually up to an indeterminable common phase bias γ instead of only certain relations between rᵢ and tᵢ as in the weaker form of calibration.

When using multiple APs for these applications, each AP can be individually strongly calibrated. However, for two APs to operate phase-coherently together so that the array collectively formed by their antennas is strongly calibrated, their internal clocks (or phase alignment errors) need to be aligned. This requires bidirectional measurements between the APs. This is because, for example, the common clock bias, denoted γ₁, at one AP differs from the common clock bias, denoted γ₂, at another AP.

Knowledge of the propagation channel coefficients between antennas of different APs are needed for being able to directly applying the methodology for strong calibration of a single multiple-antenna AP where the mutual coupling channel coefficients need to be known to achieve strong calibration within an AP. This knowledge is needed to be able to perform joint strong calibration of both APs. However, the propagation channel between the AP is still unknown. Using narrowband bi-directional measurements between APs to strongly calibrate the array without knowledge of such propagation channel coefficients results in a phase ambiguity. In more detail, if narrowband bidirectional phase measurements are used for strong calibration of two APs, the resulting phase alignment will be subject to an ambiguity of 0 versus. 180 degrees (or 0 versus π radians). This ambiguity is detrimental if the APs are going to be used for any application that requires unambiguous phase alignment. Some non-limiting examples of such applications are positioning, angle-of-arrival estimation, and sensing. It is also an issue if multiple APs are to phase-coherently cooperate for DL beamforming without channel state information obtained from UL pilot signals.

### SUMMARY

An object of embodiments herein is to provide address the above issues by providing accurate phase difference estimation between two APs.

According to a first aspect there is presented a method for estimating a phase difference between a first AP and a second AP. The method comprises obtaining a first phase difference Dₐ and a second phase difference D_{b} between the first AP and the second AP from phase measurements on a first wideband signal having been transmitted by the first AP and received by the second AP and phase measurements on a second wideband signal having been transmitted by the second AP and received by the first AP. The first phase difference is associated with a first metric and the second phase difference is associated with a second metric. The method comprises performing hypothesis testing for selecting one of the first phase difference and the second phase difference as the estimated phase difference between the first AP and the second AP based on which of the first metric and the second metric that best matches a hypothesis metric.

According to a second aspect there is presented a network node for estimating a phase difference between a first AP and a second AP. The network node comprises processing circuitry. The processing circuitry is configured to cause the network node to obtain a first phase difference Dₐ and a second phase difference D_{b} between the first AP and the second AP from phase measurements on a first wideband signal having been transmitted by the first AP and received by the second AP and phase measurements on a second wideband signal having been transmitted by the second AP and received by the first AP. The first phase difference is associated with a first metric and the second phase difference is associated with a second metric. The processing circuitry is configured to cause the network node to perform hypothesis testing for selecting one of the first phase difference and the second phase difference as the estimated phase difference between the first AP and the second AP based on which of the first metric and the second metric that best matches a hypothesis metric.

According to a third aspect there is presented a network node for estimating a phase difference between a first AP and a second AP. The network node comprises an obtain module configured to obtain a first phase difference Dₐ and a second phase difference D_{b} between the first AP and the second AP from phase measurements on a first wideband signal having been transmitted by the first AP and received by the second AP and phase measurements on a second wideband signal having been transmitted by the second AP and received by the first AP. The first phase difference is associated with a first metric and the second phase difference is associated with a second metric. The network node comprises a test module configured to perform hypothesis testing for selecting one of the first phase difference and the second phase difference as the estimated phase difference between the first AP and the second AP based on which of the first metric and the second metric that best matches a hypothesis metric.

According to a fourth aspect there is presented a computer program for estimating a phase difference between a first AP and a second AP, the computer program comprising computer program code which, when run on a network node, causes the network node to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects can be used to resolve the phase ambiguity which results from using narrowband bidirectional phase measurement schemes as disclosed above for strong calibration of distributed antenna arrays.

Advantageously, these aspects can be used in the context of positioning of, and angle-of-arrival estimation to, user equipment served by the APs.

Advantageously, these aspects can be used in the context of sensing applications that use fingerprinting of channel impulse responses.

Advantageously, these aspects can be used in the context of broadcasting schemes, for example for system information, paging messages or to wake up passive devices, that use beam-sweeping coherently from multiple APs or rely on a parametric channel model (e.g. information on the geometry).

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a flowchart of methods according to embodiments;

FIG. 3 schematically illustrates candidate values of the propagation delay according to examples;

FIG. 4 schematically illustrates candidate values of the propagation delay according to a first example;

FIG. 5 schematically illustrates candidate values of the propagation delay according to a second example;

FIG. 6 is a schematic diagram showing functional units of a network node according to an embodiment;

FIG. 7 is a schematic diagram showing functional modules of a network node according to an embodiment; and

FIG. 8 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

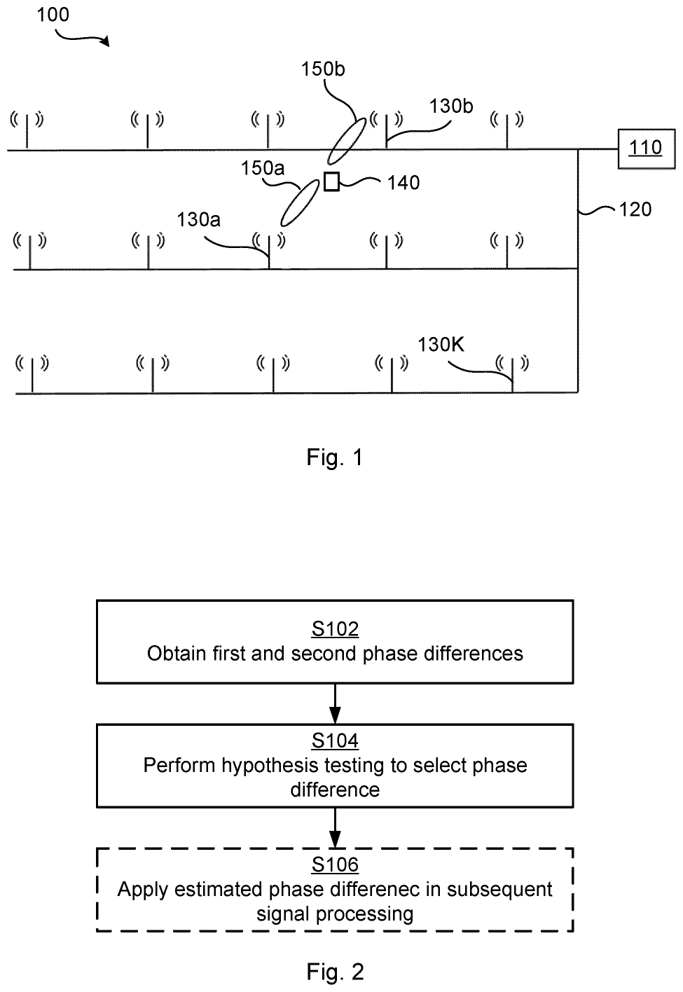

FIG. 1 is a schematic diagram illustrating a communication network 100 where embodiments presented herein can be applied. The communication network 100 comprises K APs, three of which are identified at reference numerals 130a, 130b, 130K. In this respect, the herein disclosed embodiments are not limited to any particular number of APs 130a: 130K as long as there are at least two APs 130a: 130K. Each AP 130a: 130K could be a (radio) access network node, radio base station, base transceiver station, node B (NB), evolved node B (eNB), gNB, integrated access and backhaul (IAB) node, one or more distributed antenna, or the like. The APs 130a: 130K operatively connected over interfaces 120 to a centralized node 110, which could represent a core network. The centralized node 110 could be a (radio) base station, or the like. The APs 130a: 130K are configured to provide network access to user equipment (UE) 140. Each such UE 140 could be any of a portable wireless device, mobile station, mobile phone, handset, wireless local loop phone, smartphone, laptop computer, tablet computer, wireless modem, wireless sensor device, Internet of Things (IoT) device, network equipped vehicle, or the like. Each such UE 140 is configured for wireless communication with the APs 130a: 130K. In some examples, the APs 130a: 130K use beamforming for this communication, as represented by beams 150a, 150b. In some aspects, the communications network 100 is a D-MIMO network. Hence, in some examples, the APs 130a: 130K are part of a D-MIMO network.

As disclosed above, there are two types of calibrations under consideration; (i) weak reciprocity calibration, which is sufficient for antenna arrays that are to perform reciprocity-based beamforming, and (ii) strong reciprocity calibration, which is required if the arrays are used for angle measurements. Strong calibration in turn requires knowledge of the coupling coefficients between the antennas, obtained for example from measurements in an anechoic chamber or from testing of the AP in the field.

In the present disclosure is disclosed techniques that are suitable for a new type of calibration between APs. This new type of calibration can be regarded as a third type of calibration, aligning two strongly calibrated APs such that the total array collectively formed by all antennas of the APs becomes strongly calibrated, without requiring knowledge of the coupling coefficients, or in this case the channel coefficients between arrays. This is accomplished by using wideband signals for obtaining bidirectional phase measurements with respect to the APs. This wideband signal can, for example, be composed of a superposition of two narrowband signals (e.g., two sinusoids or two signals located at two particular orthogonal frequency-division multiplexing (OFDM) frequency subcarriers in). But also other types of wideband signals are possible. The use of a wideband signal stands in contrast to narrowband signals used for weak/strong calibration as referred to above and is required to resolve a 0/π-phase ambiguity that arises from using narrowband bi-directional measurements to phase align two antenna arrays.

The embodiments disclosed herein in particular relate to techniques for estimating a phase difference between a first AP 130a and a second AP 130b. In order to obtain such techniques there is provided a network node 600, 700, a method performed by the network node 600, 700, a computer program product comprising code, for example in the form of a computer program, that when run on a network node 600, 700, causes the network node 600, 700 to perform the method. Functionality of the network node 600, 700 might be implemented in the first AP 130a or the second AP 130b, or partly implemented in the first AP 130a and partly implemented the second AP 130b, or be implemented in node, such as the centralized node 110, physically separated from at least one of the first AP 130a and the second AP 130b.

Consider a physical model with two APs; AP1 and AP2, that have been individually and strongly calibrated as described above. Then, by applying appropriate pre-compensation, it can be assumed that rₖ=tₖ, where k=1, 2 is the AP index. This can be accomplished, for example, by subtracting the offset per antenna transmit/receive branch (which is known up to a constant) from all phase values associated with that branch. Let pₖ be the common value of the phase error at AP k: pₖ=rₖ=tₖ. With these definitions, the sought-after phase alignment error is

$$D = {p}_{1} - {p}_{2} .$$

A detailed explanation as to why a phase ambiguity arises will be disclosed next.

Application of bidirectional protocols based on narrowband measurements for calibration result in a π-ambiguity when estimating the phase alignment error D. To further illustrate this, consider the following non-limiting illustrative example of a baseline protocol for bidirectional alignment.

AP1 sends a first signal, that could be a sinusoid, or simply a symbol located somewhere on an OFDM time-frequency grid. This first signal is aligned with the local phasor of AP1; without loss of generality, it has zero transmitted phase at a point in time when the local phasor of AP1 is zero. AP2 measures on this first signal, and notes the value of its local phasor at the point in time when the received signal has zero phase at AP2. This yields the following phase observation (neglecting measurement noise for now):

$${d}_{12} = {p}_{2} - {p}_{1} + T mod 2 π , \qquad ( 1 )$$

where T is the propagation delay expressed in radians, and where mod denotes the modulo operation. That is, T=2πΔ/2, where λ=c/f_{c} is the wavelength, Δ is the distance between AP1 and AP2 and c is the speed of light. If the distance changes by an integer multiple of a wavelength, then d₁₂ remains unchanged. If the propagation delay T were known, then D could be immediately obtained from the measurement (1). However, T is unknown.

To address the problem that T is unknown, a second measurement is used. To facilitate this, AP2 sends a second signal, aligned such that the second signal has zero phase when the local phasor of AP2 is zero. Similar to the above, AP1 obtains the observation:

$${d}_{21} = {p}_{1} - {p}_{2} + T mod 2 π . \qquad ( 2 )$$

Treating expressions (1)-(2) as a linear system of equations, T can be eliminated modulo 2π, which yields:

$$2 D = {d}_{21} - {d}_{12} mod 2 π , \qquad ( 3 )$$

from which the phase alignment error D can be computed, however, only up to an ambiguity of π. Specifically, the ambiguity is that if D=D* satisfies equation (3), then D=D*+π does, too.

Methods to resolve the phase ambiguity resulting from application of the baseline protocol will be disclosed next.

FIG. 2 is a flowchart illustrating embodiments of methods for estimating a phase difference between a first AP 130a and a second AP 130b. The methods are advantageously provided as computer programs 820.

The methods are based on using bidirectional phase measurement of wideband signals for aligning the first AP 130a and the second AP 130b such that the total array collectively formed by all antennas of the first AP 130a and the second AP 130b becomes strongly calibrated.

S102: A first phase difference Dₐ and a second phase difference D_{b} between the first AP 130a and the second AP 130b are obtained. The first and second phase differences are obtained from phase measurements on a first wideband signal having been transmitted by the first AP 130a and received by the second AP 130b and phase measurements on a second wideband signal having been transmitted by the second AP 130b and received by the first AP 130a. The first phase difference is associated with a first metric and the second phase difference is associated with a second metric.

Hence, the second AP 130b might perform the phase measurements on the first wideband signal and the first AP 130a might perform the phase measurements on the second wideband signal. Examples of metrics will be disclosed below.

S104: Hypothesis testing is performed for selecting one of the first phase difference and the second phase difference as the estimated phase difference between the first AP 130a and the second AP 130b. Which of the first phase difference and the second phase difference that is selected is based on which of the first metric and the second metric that best matches a hypothesis metric. Examples of how to perform the hypothesis testing will be disclosed below. Examples of the hypothesis metric will be disclosed below.

The method defined by steps S102 and S104 might be regarded as bidirectional phase measurements being performed to ensure strong reciprocity calibration up to a 0/π-ambiguity. The distance, expressed in terms of path length, between the two APs 130a, 130b can be estimated, which facilitates resolution of the 0/π-ambiguity.

Advantageously, these aspects can be used to resolve the phase ambiguity which results from using narrowband bidirectional phase measurement schemes as disclosed above for strong calibration of distributed antenna arrays.

Advantageously, these aspects can be used in the context of positioning of, and angle-of-arrival estimation to, user equipment served by the APs.

Advantageously, these aspects can be used in the context of sensing applications that use fingerprinting of channel impulse responses.

Advantageously, these aspects can be used in the context of broadcasting schemes, for example for system information, paging messages or to wake up passive devices, that use beam-sweeping coherently from multiple APs or rely on a parametric channel model (e.g. information on the geometry).

Embodiments relating to further details of estimating the phase difference between the first AP 130a and the second AP 130b will now be disclosed.

In some aspects, it is assumed that each of the first AP 130a and the second AP 130b comprises a respective locally calibrated antenna array at which the first and the second wideband signals are transmitted and received.

To illustrate the utility of using wideband signals, it is here assumed that each of the first wideband signal and the second wideband signal is a respective superposition of two narrowband signals that have slightly different center frequencies, say f and f′. Hence, in some examples each of the first and the second wideband signals is composed of two narrowband component signals that are separated in frequency. Both f and f′ are close to the carrier frequency, so f≈f_{c} and f′≈f_{c}. In this respect, f, f′ could be different between the transmission from the transmission from the first AP 130a towards the second AP 130b and the transmission from the second AP 130b towards the first AP 130a. Appropriate preprocessing of the measurements is then necessary.

In practice, for example in an OFDM system, such wideband signals can be generated by transmitting two symbols on two different subcarriers with some frequency separation. Therefore, in some examples, the second wideband signal is partially overlapping in frequency with the first wideband signal.

Further, the herein disclosed embodiments are also applicable to arbitrary formed wideband signals, not necessarily composed of a superposition of narrowband signals with different center frequencies. Such arbitrary formed wideband signals would facilitate a rough estimation of the distance between the two APs 130a, 130b, for example by using correlation-based methods for time-delay estimation.

The two frequencies f and f′ are associated with slightly different propagation delays, when measured in radians. Specifically, denote by T and T′ these propagation delay in radians associated with the two frequencies f and f′ when such signals travel through the same propagation path. Then, T=2πΔf/c and T′=2πΔf′/c. Hence T′=aT, where a=f′/f. It is assumed here, without loss of generality, that a<1 and thus that f′<f. This follows since a higher frequency means a shorter wavelength, which means a larger propagation delay when expressed in radians.

The use of two component signals, with frequencies at f and f′, respectively, with bidirectional signalling yields four phase measurements. Neglecting measurement noise, these phase measurements are given by the following set of measurement expressions:

$${d}_{21} = D + T , \qquad ( 4 a )$$

$${d}_{12} = - D + T , \qquad ( 4 b )$$

$${d}_{21}^{′} = D + {T}^{′} , \qquad ( 4 c )$$

$${d}_{12}^{′} = - D + {T}^{′} , \qquad ( 4 d )$$

Here, D is the phase-alignment error as defined in expression (3), d₁₂ and d₂₁ are obtained from the measurement on the first wideband signal, and d′₁₂ and d′₂₁ are obtained from the measurement on the second wideband signal. There are thus three unknowns: D, T and T′ (where T and T′ are linearly related). It is noted that for expressions (4a)-(4d) as well as in the below expression, all equalities will be modulo 2π. This is since the phase can only be defined up to an integer multiple of 21.

From expressions (4a)-(4d) the object is now to form an estimate of D. If the measurements on the first wideband signal according to expressions (4a)-(4b) are used in the spirit of the baseline protocol, eliminating T as described there, it can be concluded that D is one of the two values Dₐ or D_{b} defined as follows:

$${D}_{a} = ( {d}_{21} - {d}_{12} ) / 2 , \qquad ( 5 a )$$

$${D}_{b} = ( {d}_{21} - {d}_{12} ) / 2 + π , \qquad ( 5 b )$$

Hence, in some embodiments, the first phase difference Dₐ and the second phase difference D_{b} differ by π mod 2π.

Expressions (5a) and (5b) are examples of where the first phase difference Dₐ and the second phase difference D_{b} are functions of a true phase difference D between the first AP 130a and the second AP 130b and either a true propagation delay T for the first wideband signal or a true propagation delay T′ for the second wideband signal. Likewise, if the measurements on the second wideband signal according to expressions (4c)-(4d) instead, an estimate (up to the π-ambiguity) expressed as a function of {d′₁₂, d′₂₁} can be formed instead. That is, according to expression (5a), the first phase difference Dₐ is either expressed as Dₐ=(d₂₁−d₁₂)/2, where d₂₁=D+T and d₁₂=−D+T, or expressed as Dₐ=(d′₂₁−d′₁₂)/2, where d′₂₁=D+T′ and d′₁₂=−D+T′. Further, according to expression (5b), the second phase difference D_{b} is either expressed as D_{b}=(d₂₁−d₁₂)/2+π, where d₂₁=D+T and d₁₂=−D+T, or expressed as D_{b}=(d′₂₁−d′₁₂)/2+π, where d′₂₁=D+T′ and d′₁₂=−D+T′.

Averages of estimates formed from expressions (4a)-(4b) and from (4c)-(4d) could be advantageously used in case the measurement noise is not negligible.

To resolve which one of Dₐ and D_{b} in expression (5a)-(5b) that is correct, all measurements as given by expressions (4a)-(4d) can be jointly used. One example of how to proceed is as follows. Observing expressions (4a)-(4b) and solving instead for T, it can be concluded that T is one of the two values Tₐ or T_{b} defined as follows:

$${T}_{a} = ( {d}_{21} + {d}_{12} ) / 2 , \qquad ( 6 a )$$

$${T}_{b} = ( {d}_{21} + {d}_{12} ) / 2 + π , \qquad ( 6 b )$$

Therefore, in some embodiments, the first metric is a first propagation delay Tₐ between the first AP 130a and the second AP 130b, and the second metric is a second propagation delay T_{b} between the first AP 130a and the second AP 130b.

Expressions (6a) and (6b) are examples of where the first propagation delay Tₐ and the second propagation delay T_{b} are functions of a true phase difference D between the first AP (130a) and the second AP (130b) and either a true propagation delay T for the first wideband signal or a true propagation delay T′ for the second wideband signal. According to expression (6a), the first propagation delay Tₐ is either expressed as Tₐ=(d₂₁+d₁₂)/2, where d₂₁=D+T and d₁₂=−D+T, or expressed as Tₐ=(d′₂₁+d₁₂)/2, where d′₂₁=D+T′ and d′₁₂=−D+T′. Further, according to expression (6b), the second propagation delay T_{b} is either expressed as T_{b}=(d₂₁+d₁₂)/2+π, where d₂₁=D+T and d₁₂=−D+T, or expressed as T_{b}=(d′₂₁+d′₁₂)/2+π, where d′₂₁=D+T′ and d′₁₂=−D+T′.

From expressions (6a) and (6b) follows that the first propagation delay Tₐ and the second propagation delay T_{b} differ by π mod 2π.

From expressions (4a) and (4c) it can concurrently be concluded that:

$$( 1 - a ) T = T - {T}^{′} = {d}_{21} - {d}_{21}^{′} mod 2 π \qquad ( 7 )$$

Therefore, in some embodiments, the hypothesis metric is a hypothesis propagation delay \hat{T}, where the hypothesis testing is based on which of the first propagation delay and the second propagation delay that best matches the hypothesis propagation delay \hat{T}. From expression (7) it follows that:

$$T = \hat{T} mod 2 π / ( 1 - a ) \qquad ( 8 )$$

$$where$$

$$\hat{T} = ( {d}_{21} - {d}_{21}^{′} ) / ( 1 - a ) .$$

Hence, in some embodiments, the hypothesis propagation delay \hat{T} is a function either of a combination of d₂₁, d′₂₁, a center frequency f of the first wideband signal, and a center frequency f′ of the second wideband signal, or of a combination of d₁₂, d′₁₂, f and f′, where d₂₁ is a function of the true phase difference D and the true propagation delay T for the first wideband signal, and d′₂₁ is a function of the true phase difference D and the true propagation delay T′ for the second wideband signal.

Expression (8) is an example where the hypothesis propagation delay \hat{T} is either expressed as \hat{T}=(d₂₁−d′₂₁)/(1−a), or expressed as \hat{T}=(d₁₂−d′₁₂)/(1−a), where a=f′/f.

It can then be checked which of Tₐ+m2π and T_{b}+m2π in expressions (6a)-(6b) that matches most closely with \hat{T}+n2π/(1−a), for some combination of integers m and n. Absent of measurement noise, one of them will match exactly. Hence, in some embodiments, performing the hypothesis testing comprises checking which of which of Tₐ+m2π and T_{b}+m2π that matches most closely with \hat{T}+n2π/(1−a) for some combination of integers m and n. If the match is best for Tₐ then it can be concluded that D=Dₐ, and otherwise it can be concluded that D=D_{b}.

Instead of forming Tₐ and T_{b} from expressions (4a)-(4b), expressions (4c)-(4d) can be used instead. Alternatively, an average of the two estimates formed this way can be used. This may be useful if measurement noise is present. Further, rather than obtaining T in expression (8) from expressions (4a) and (4c), it is possible to obtain T from expressions (4b) and (4d), or, from an average of the estimate obtained from expressions (4a) and (4c) the estimate obtained from expressions (4b) and (4d).

One physical interpretation of the procedure is that the distance between AP1 and AP2 is estimated (roughly, and modulo 2π/(1−a) radians), using a probing signal with bandwidth f−f′. The distance estimated this way is then used as side information when resolving the π-ambiguity in the phase alignment.

In some examples it is assumed that the propagation distance is the same at f and f′. Therefore, in some embodiments, the phase measurements are obtained from the first wideband signal and the second wideband signal as transmitted over same propagation path. This is the case, for example, in line-of-sight conditions between the first AP 130a and the second AP 130b. Beamforming can be applied at the APs 130a, 130b to ensure line-of-sight conditions.

As disclosed above, averaging can be performed to reduce measurement noise. Hence, some embodiments, the phase measurements represent averaged measurements on at least two occurrences of the first wideband signal and/or at least two occurrences of the second wideband signal. More generally the task of determining D while {T, T′} are unknown could be cast as a (mixed-integer) regression problem.

If the phase characteristics of the antennas of the APs 130a, 130b varies across frequency, compensations for this (known) variation can be made to ensure that the propagation delays T and T′ are as given above (up to a common phase rotation). However, this will not affect the methods disclosed herein since only differences between measured phases are used.

In some aspects, the estimated phase difference is applied during subsequent signal processing at the first AP 130a and/or the second AP 130b. Hence, in some embodiments, the method comprises (optional) step S106 to be performed.

S106: The estimated phase difference is applied in subsequent signal processing in at least one of the first AP 130a and the second AP 130b.

There could be different examples of signal processing where the estimated phase difference is applied. In some non-limiting examples, the subsequent signal processing involves at least one of: calibrating at least one of the first AP 130a and the second AP 130b as a function of the estimated phase difference, performing beamformed signal transmission and/or reception in at least one of the first AP 130a and the second AP 130b as a function of the estimated phase difference, performing positioning of the first AP 130a and the second AP 130b relative each other, tracking a user equipment 140 served by the first AP 130a and the second AP 130b. Hence, the estimated phase difference is not necessarily used for calibrating the first AP 130a and/or the second AP 130b, but the estimated phase difference has also different uses.

Two illustrative examples will be disclosed next. In both examples, the wideband signals are at a 2 GHz carrier with a separation of 5 MHz, specifically, f=2 GHz, and f′=f−5 MHz. Then a=0.9975. In both examples, it is further assumed that the physical distance between the two APs is Δ=11 meters. Then T=2.0944 and T′=0.9425 radians (modulo 2π). It is finally assumed that there is not any measurement noise impacting the calculations.

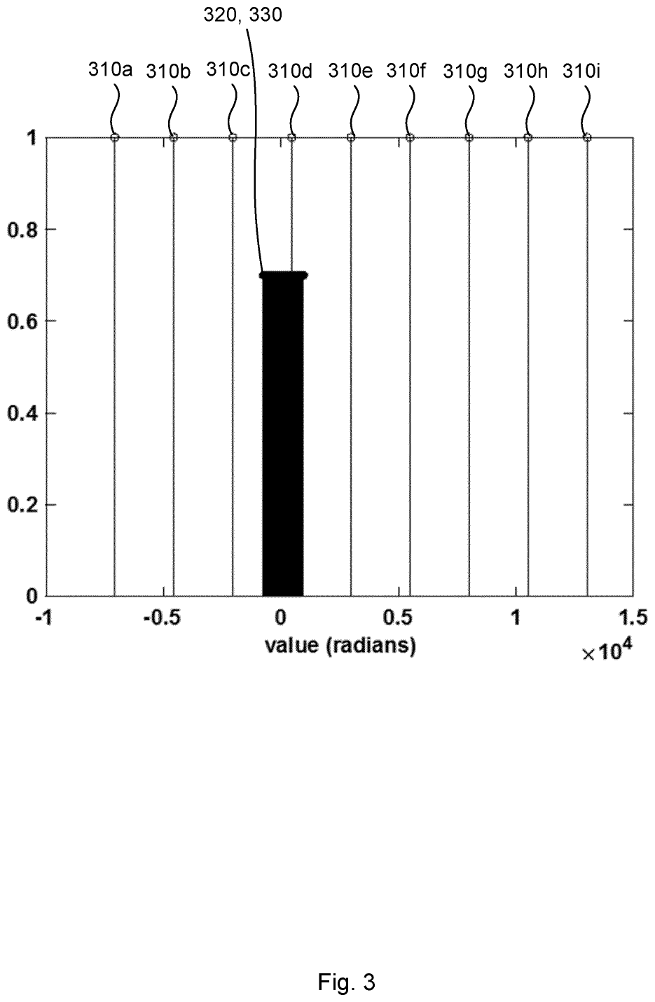

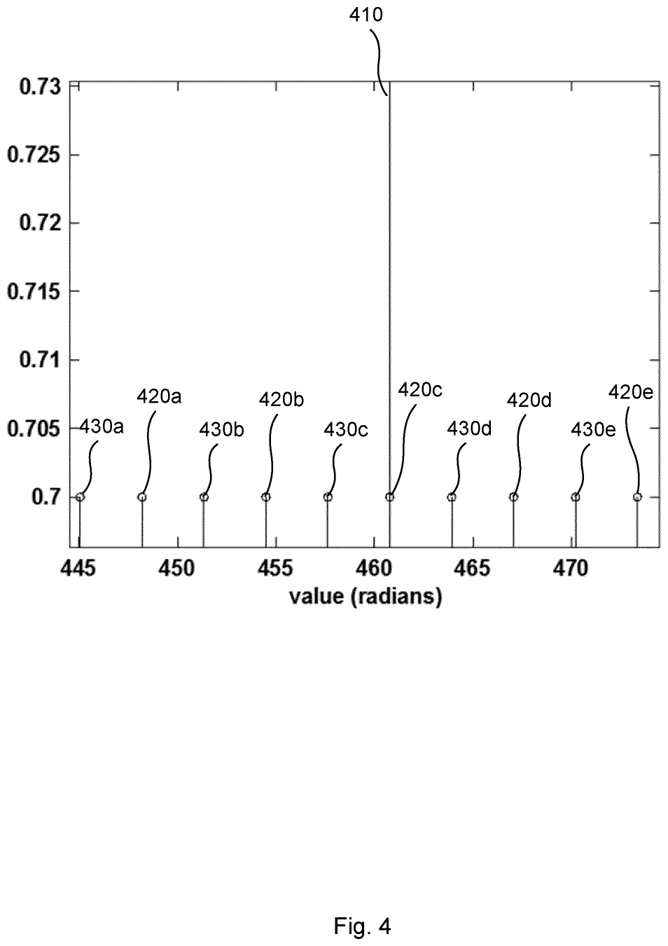

Example 1: Take p₁=0.3π and p₂=0.2π; then D=0.1π=0.314. The noise-free measurements are d₁₂=1.78, d₂₁=2.41, d₁₂=0.63 and d₂₁=1.26. The disclosed method first determines the candidate values for D as follows: Dₐ=0.314 and D_{b}=3.456. The disclosed method next determines that Tₐ=2.094 and T_{b}=5.236, where all these numbers are modulo 2π. The disclosed method next computes \hat{T}=460.77. To perform the match, we combinations of Tₐ+m2π and T_{b}+m2π are checked against \hat{T}+n2π/(1−a), for combinations of the integers m and n. Reference is here made to FIG. 3 and FIG. 4. FIG. 3 at 310a: 310i shows possible values for \hat{T} and at 320 and 330 show collections of different possible values for Tₐ and T_{b}. FIG. 4 provides a zoomed-in version of FIG. 3, where the value for \hat{T} at reference numeral 310d in FIG. 3 can be seen at reference numeral 410, where the collection of values 320 for Tₐ can be seen at reference numerals 420a:420e, and where the collection of values 330 for T_{b} can be seen at reference numerals 430a:430e. It can thus be seen that the value at reference numeral 420c matches the value at reference numeral 410. It can therefore be concluded that Tₐ is the correct hypothesis and thus that D=Dₐ=0.314 in this example.

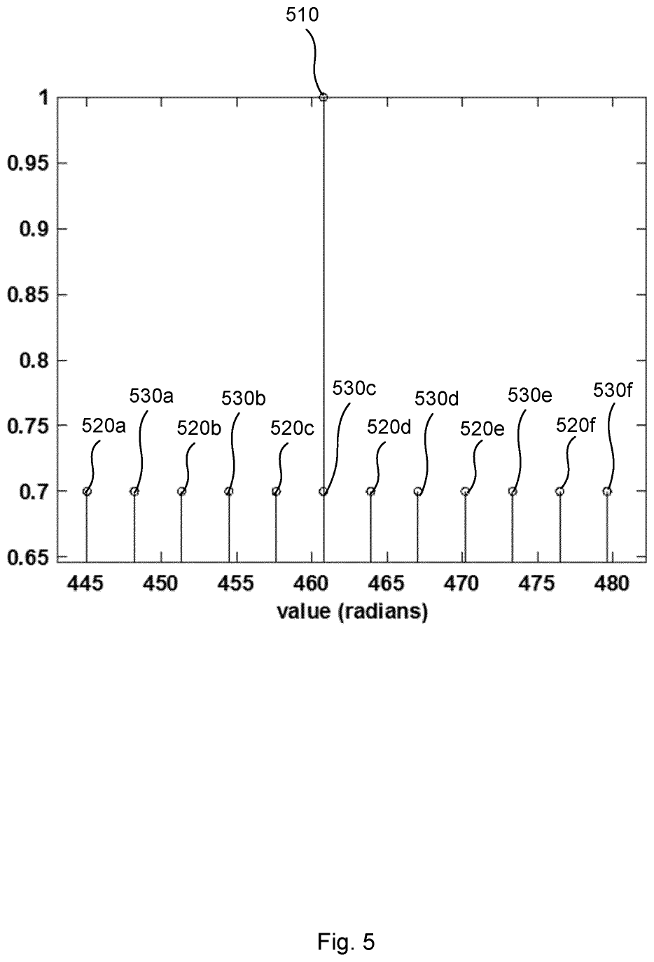

Example 2: The same values as in Example 1 are used, except that p₁=0.9π and p₂=0.2π. In this case, D=2.20, Dₐ=−5.34 and D_{b}=2.20. FIG. 5 shows one value for \hat{T} at reference numeral 510, a collection of values 520a:520f for Tₐ, and a collection of values 530a:530f for T_{b}. It can thus be seen that the value at reference numeral 530c matches the value at reference numeral 510. It can therefore be concluded that T_{b} is the correct hypothesis and thus that D=D_{b}=2.20 in this example.

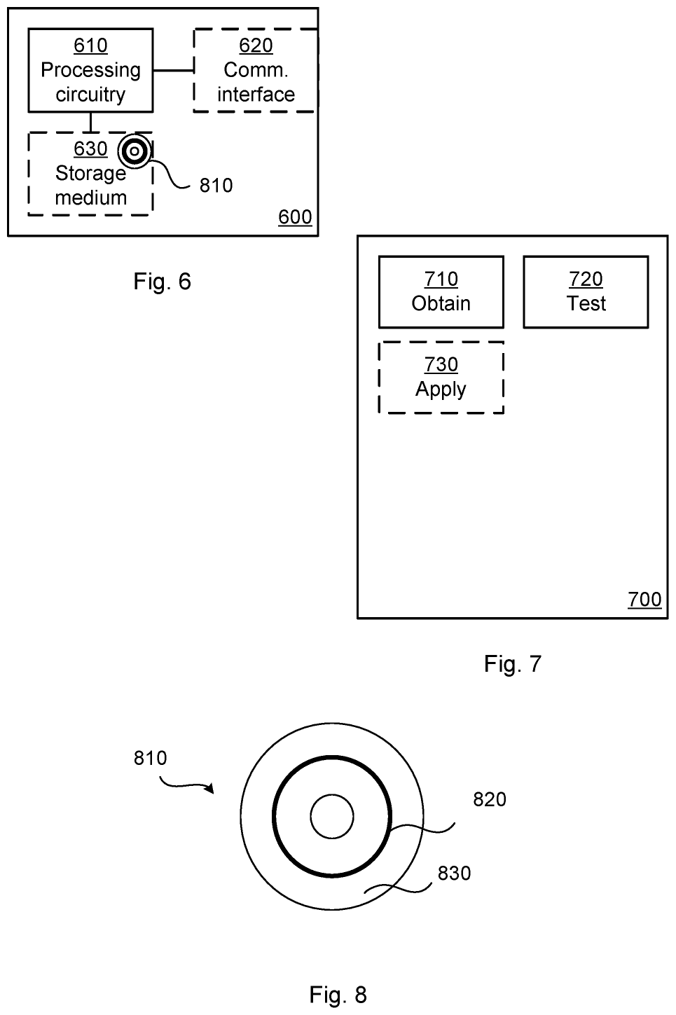

FIG. 6 schematically illustrates, in terms of a number of functional units, the components of a network node 600 according to an embodiment. Processing circuitry 610 is provided using any combination of one or more of a suitable central processing unit (CPU), multiprocessor, microcontroller, digital signal processor (DSP), etc., capable of executing software instructions stored in a computer program product 810 (as in FIG. 8), e.g. in the form of a storage medium 630. The processing circuitry 610 may further be provided as at least one application specific integrated circuit (ASIC), or field programmable gate array (FPGA).

Particularly, the processing circuitry 610 is configured to cause the network node 600 to perform a set of operations, or steps, as disclosed above. For example, the storage medium 630 may store the set of operations, and the processing circuitry 610 may be configured to retrieve the set of operations from the storage medium 630 to cause the network node 600 to perform the set of operations. The set of operations may be provided as a set of executable instructions.

Thus the processing circuitry 610 is thereby arranged to execute methods as herein disclosed. The storage medium 630 may also comprise persistent storage, which, for example, can be any single one or combination of magnetic memory, optical memory, solid state memory or even remotely mounted memory. The network node 600 may further comprise a communications interface 620 at least configured for communications with the APs 130a:130K. As such the communications interface 620 may comprise one or more transmitters and receivers, comprising analogue and digital components. The processing circuitry 610 controls the general operation of the network node 600 e.g. by sending data and control signals to the communications interface 620 and the storage medium 630, by receiving data and reports from the communications interface 620, and by retrieving data and instructions from the storage medium 630. Other components, as well as the related functionality, of the network node 600 are omitted in order not to obscure the concepts presented herein.

FIG. 7 schematically illustrates, in terms of a number of functional modules, the components of a network node 700 according to an embodiment. The network node 700 of FIG. 7 comprises a number of functional modules; an obtain module 710 configured to perform step S102, and a test module 720 configured to perform step S104. The network node 700 of FIG. 7 may further comprise a number of optional functional modules, such as an apply module 730 configured to perform step S106. In general terms, each functional module 710:730 may in one embodiment be implemented only in hardware and in another embodiment with the help of software, i.e., the latter embodiment having computer program instructions stored on the storage medium 630 which when run on the processing circuitry makes the network node 700 perform the corresponding steps mentioned above in conjunction with FIG. 7. It should also be mentioned that even though the modules correspond to parts of a computer program, they do not need to be separate modules therein, but the way in which they are implemented in software is dependent on the programming language used. Preferably, one or more or all functional modules 710:730 may be implemented by the processing circuitry 610, possibly in cooperation with the communications interface 620 and/or the storage medium 630. The processing circuitry 610 may thus be configured to from the storage medium 630 fetch instructions as provided by a functional module 710:730 and to execute these instructions, thereby performing any steps as disclosed herein.

The network node 600, 700 may be provided as a standalone device or as a part of at least one further device. For example, the network node 600, 700 may be a part of, collocated with, or integrated with the first AP 130a or the second AP 130b, or any other AP, or the centralized node 110. Alternatively, functionality of the network node 600, 700 may be distributed between at least two entities, such as between the first AP 130a and the second AP 130b and/or the centralized node 110. In general terms, instructions that are required to be performed in real time may be performed in a device, or node, operatively closer to the cell than instructions that are not required to be performed in real time. Thus, a first portion of the instructions performed by the network node 600, 700 may be executed in a first device, and a second portion of the of the instructions performed by the network node 600, 700 may be executed in a second device; the herein disclosed embodiments are not limited to any particular number of devices on which the instructions performed by the network node 600, 700 may be executed. Hence, the methods according to the herein disclosed embodiments are suitable to be performed by a network node 600, 700 residing in a cloud computational environment. Therefore, although a single processing circuitry 610 is illustrated in FIG. 6 the processing circuitry 610 may be distributed among a plurality of devices, or nodes. The same applies to the functional modules 710:730 of FIG. 7 and the computer program 820 of FIG. 8.

FIG. 8 shows one example of a computer program product 810 comprising computer readable storage medium 830. On this computer readable storage medium 830, a computer program 820 can be stored, which computer program 820 can cause the processing circuitry 610 and thereto operatively coupled entities and devices, such as the communications interface 620 and the storage medium 630, to execute methods according to embodiments described herein. The computer program 820 and/or computer program product 810 may thus provide means for performing any steps as herein disclosed.

In the example of FIG. 8, the computer program product 810 is illustrated as an optical disc, such as a CD (compact disc) or a DVD (digital versatile disc) or a Blu-Ray disc. The computer program product 810 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 820 is here schematically shown as a track on the depicted optical disk, the computer program 820 can be stored in any way which is suitable for the computer program product 810.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for estimating a phase difference between a first access point (AP) and a second AP, the method comprising:
obtaining a first phase difference Dₐ and a second phase difference D_{b} between the first AP and the second AP from phase measurements on a first wideband signal having been transmitted by the first AP and received by the second AP and phase measurements on a second wideband signal having been transmitted by the second AP and received by the first AP, wherein the first phase difference is associated with a first metric and the second phase difference is associated with a second metric; and
performing hypothesis testing for selecting one of the first phase difference and the second phase difference as the estimated phase difference between the first AP and the second AP based on which of the first metric and the second metric that best matches a hypothesis metric.

2. The method of claim 1, wherein the method further comprises:
applying the estimated phase difference in subsequent signal processing in at least one of the first AP and the second AP.

3. The method of claim 2, wherein the subsequent signal processing involves at least one of: calibrating at least one of the first AP and the second AP as a function of the estimated phase difference, performing beamformed signal transmission and/or reception in at least one of the first AP and the second AP as a function of the estimated phase difference, performing positioning of the first AP and the second AP relative each other, tracking a user equipment served by the first AP and the second AP.

4. The method of claim 1, wherein each of the first AP and the second AP comprises a respective locally calibrated antenna array at which the first and the second wideband signals are transmitted and received.

5. The method of claim 1, wherein each of the first and the second wideband signals is composed of two narrowband component signals that are separated in frequency.

6. The method of claim 1, wherein the second wideband signal is partially overlapping in frequency with the first wideband signal.

7. The method of claim 1, wherein the phase measurements represent averaged measurements on at least two occurrences of the first wideband signal and/or at least two occurrences of the second wideband signal.

8. The method of claim 1, wherein the first phase difference Dₐ and the second phase difference D_{b} differ by π mod 2π.

9. The method of claim 1, wherein the first phase difference Dₐ and the second phase difference D_{b} are functions of a true phase difference D between the first AP and the second AP and either a true propagation delay T for the first wideband signal or a true propagation delay T′ for the second wideband signal.

10. The method of claim 9, wherein the first phase difference Dₐ is either expressed as Dₐ=(d₂₁−d₁₂)/2, where d₂₁=D+T and d₁₂=−D+T, or expressed as Dₐ=(d′₂₁−d′₁₂)/2, where d′₂₁=D+T′ and d′₁₂=−D+T′, and
the second phase difference D_{b} is either expressed as D_{b}=(d₂₁−d₁₂)/2+π, where d₂₁=D+T and d₁₂=−D+T, or expressed as D_{b}=(d′₂₁−d′₁₂)/2+π, where d₂₁=D+T′ and d′₁₂=−D+T′.

11. (canceled)

12. The method of claim 1, wherein the first metric is a first propagation delay Tₐ between the first AP and the second AP, and the second metric is a second propagation delay T_{b} between the first AP and the second AP.

13. The method of claim 12, wherein the hypothesis metric is a hypothesis propagation delay \hat{T}, and wherein the hypothesis testing is based on which of the first propagation delay and the second propagation delay that best matches the hypothesis propagation delay \hat{T}.

14. The method of claim 12, wherein the first propagation delay Tₐ and the second propagation delay T_{b} differ by π mod 2π.

15. The method of claim 12, wherein the first propagation delay Tₐ and the second propagation delay T_{b} are functions of a true phase difference D between the first AP and the second AP and either a true propagation delay T for the first wideband signal or a true propagation delay T′ for the second wideband signal.

16. The method of claim 15, wherein
the first propagation delay Tₐ is either expressed as Tₐ=(d₂₁+d₁₂)/2, where d₂₁=D+T and d₁₂=−D+T, or expressed as Tₐ=(d₂₁+d₁₂)/2, where d′₂₁=D+T′ and d′₁₂=−D+T′, and
the second propagation delay T_{b} is either expressed as T_{b}=(d₂₁+d₁₂)/2+π, where d₂₁=D+T and d₁₂=−D+T, or expressed as T_{b}=(d′₂₁+d′₁₂)/2+π, where d′₂₁=D+T′ and d′₁₂=−D+T′.

17-20. (canceled)

21. The method of claim 1, wherein the phase measurements are obtained from the first wideband signal and the second wideband signal as transmitted over same propagation path.

22. The method of claim 1, wherein the first AP and the second AP are part of a distributed multiple input multiple output, D-MIMO, network.

23. The method of claim 1, wherein the method is performed by one of the first AP and the second AP, or partly performed by the first AP and partly performed by the second AP, or by a network node physically separated from at least one of the first AP and the second AP.

24. A network node for estimating a phase difference between a first access point (AP) and a second AP, the network node comprising:
memory; and
processing circuitry, the processing circuitry being configured to cause the network node to:
obtain a first phase difference Dₐ and a second phase difference D_{b} between the first AP and the second AP from phase measurements on a first wideband signal having been transmitted by the first AP and received by the second AP and phase measurements on a second wideband signal having been transmitted by the second AP and received by the first AP, wherein the first phase difference is associated with a first metric and the second phase difference is associated with a second metric; and
perform hypothesis testing for selecting one of the first phase difference and the second phase difference as the estimated phase difference between the first AP and the second AP based on which of the first metric and the second metric that best matches a hypothesis metric.

25-26. (canceled)

27. A computer program for estimating a phase difference between a first access point (AP) and a second AP, the computer program comprising computer code which, when run on processing circuitry of a network node, causes the network node to:
obtain a first phase difference Dₐ and a second phase difference D_{b} between the first AP and the second AP from phase measurements on a first wideband signal having been transmitted by the first AP and received by the second AP and phase measurements on a second wideband signal having been transmitted by the second AP and received by the first AP, wherein the first phase difference is associated with a first metric and the second phase difference is associated with a second metric; and
perform hypothesis testing for selecting one of the first phase difference and the second phase difference as the estimated phase difference between the first AP and the second AP based on which of the first metric and the second metric that best matches a hypothesis metric.

28. (canceled)
